(19) United States
(12) Patent Application Publication
(10) Pub. No.: US 2003/0184044 A1
(43) Pub. Date: Oct. 2, 2003

(54) Snowmobile back sling

(76) Inventors: Jared M. Sherburne, Meridian, ID (US); Russ E. Akers, Meridian, ID (US)

Correspondence Address: DYKAS, SHAVER & NIPPER, LLP, P O BOX 877, BOISE, ID, 83701-0877, US

(21) Appl. No.: 10/109,160

(22) Filed: Mar. 27, 2002

(51) Int. Cl. B62J 1/28

(52) U.S. Cl. 280/304.1; 297/230.1

(57) ABSTRACT

A back rest for a vehicle having a handlebar with handles. The back rest having a back contacting portion for contacting a user's back and a handlebar attachment extending from the back contacting portion for connection with at least one of the handles of the handlebar. Such a back rest allows the operator of a snowmobile, personal watercraft, or all-terrain vehicle to, when the vehicle is not in operation, comfortably sit and rest with the back support upon the seat of the vehicle.

### DESCRIPTION

### BACKGROUND OF THE INVENTION

1. Field of the Invention

The present invention generally relates to snowmobiles and other recreational vehicles, and more particularly relates to accessories for supporting a user's back when said recreational vehicle is not in operation.

2. Background Information

Thousands of individuals each year utilize snowmobiles and other recreational vehicles, including personal watercrafts and all-terrain vehicles. Such a vehicle typically has a handlebar having two handles for steering and the bench on which the rider/operator ride.

Typically, a rider will ride his/her vehicle for an extended period of time, and then the user may stop to rest, have lunch, converse with other riders, etc. Typically, when a rider arrives at such a location, the rider either will sit on the vehicle without back support, or will sit on the ground, perhaps leaning against a tree for back support. In the context of snowmobiles and personal watercraft, the problems doing so are evident.

Many methods of supporting a user's back have been invented. For instance, U.S. Pat. No. 4,195,879 (Miller) shows an infant or child's seat for snowmobiles and the like. Another example is U.S. Pat. No. 4,560,097 (Reynolds et al.) which shows a means of strapping a rear motorcycle rider onto the front motorcycle rider. The patent to Schultz (U.S. Pat. No. 4,359,129) shows a motorcycle back rest which is coupled to the frame of the motorcycle electronically, so that when the user leaves the seat of the motorcycle, the back rest detaches from the frame automatically.

What is needed is a manner of supporting a rider's back while the vehicle is not being operated, thereby allowing the rider to rest in comfort. The present invention solves these needs.

### SUMMARY OF THE INVENTION

One embodiment of the present invention is a back rest for a vehicle having a handlebar. An example of such a vehicle includes, but is not limited to, snowmobiles, a personal watercraft, and all-terrain vehicles. Such a handlebar typically will have a first end having a first handle and a second end having a second handle.

In this embodiment, the back rest comprises a back contacting portion for contacting a user's back and a handlebar attachment for connecting the back contacting portion to the handles of the handlebar. The back contacting portion has a top opposite a bottom, as well as two sides opposite one and other. The handlebar attachment preferable comprises a pair of straps attaching to the back contacting portion.

In this embodiment, the first end of each of the straps attached to the top end of the back contacting portion and the opposite ends of the straps contact the bottom side of the back contacting portion. These straps can be located at any location along the back contacting portion, including the sides. These straps (handlebar attachments) are then looped over the handles of the handlebars so that a user can rest with his back within the back contacting portion with the handlebar attachment straps extending away from the front of the user's body, wrapping around the handles, and back past the user's body attaching to the back contacting portion.

Still other objects and advantages of the present invention will become readily apparent to those skilled in this art from the following detailed description wherein we have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a perspective view of the preferred embodiment of the present invention.

FIG. 2A is a front view of a second embodiment of the present invention.

FIG. 2B is a back view of a second embodiment of the present invention.

FIG. 3A is a front view of a third embodiment of the present invention.

FIG. 3B is a back view of a third embodiment of the present invention.

FIG. 4A is a front view of a fourth embodiment of the present invention.

FIG. 4B is a back view of a fourth embodiment of the present invention.

FIG. 5 is a perspective environmental view of one embodiment of the present invention shown in use by a rider on a snowmobile.

FIG. 6A is a partial, perspective view of one embodiment of an alternative means of connecting the present invention with the handlebar(s) of a vehicle.

FIG. 6B is a side view of the embodiment shown in FIG. 6A.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

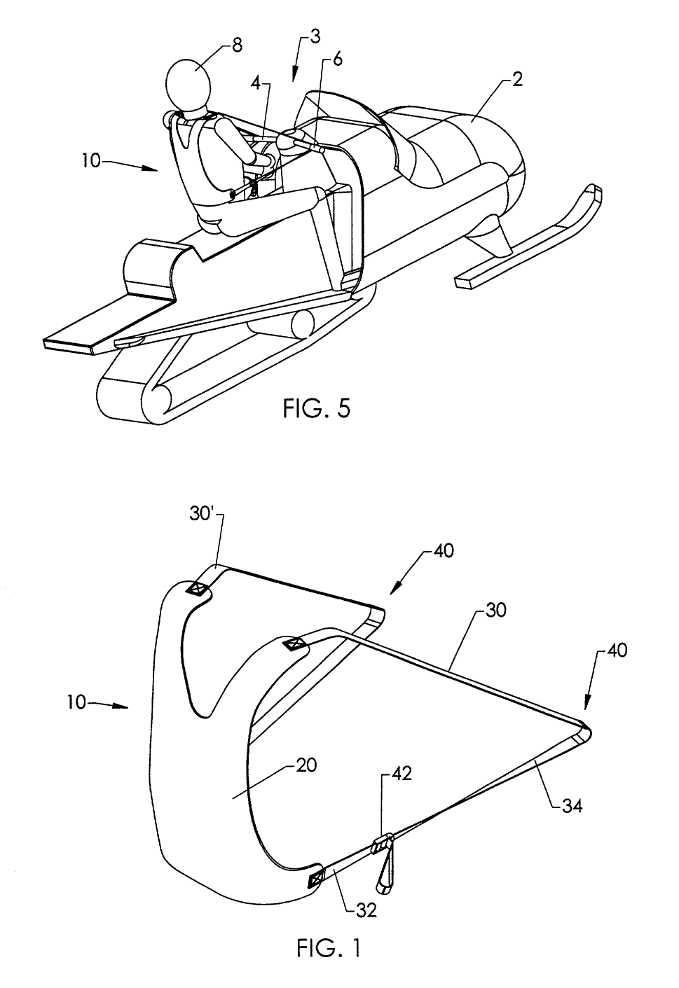

Referring initially to FIG. 1, shown is the preferred embodiment of the present invention. The invented back rest or back sling 10 comprises a back contacting portion 20 and a handlebar attachment 40. The back contacting portion 20 is for supporting and contacting the back of the operator using the present invention. The use of the word “back” is used in the default in that, of course, a user of the present invention could turn around and face rearwards utilizing the present in a less preferred sense and in such a case, the back rest would actually be supporting the user's front.

In one example embodiment, the back contacting portion 20 comprises approximately 840 square inches of fabric, for instance Codura® nylon fabric by DuPont. Any suitable material, including, but not limited to leather, cloth, cotton, polyester, canvas, plastic, webbing, netting, strapping, etc., could be utilized for the “fabric” of the back contacting portion. In a less preferred embodiment, the back contacting portion could be made out of a strap(s) or padded strap(s) itself.

In this embodiment, the handlebar attachment(s) 40 attach or connect with the handlebars through merely looping around at least one of the handles of the invention (as shown in FIG. 5). Other means of connecting the present invention with the vehicle are also envisioned, including connecting the handlebar attachment(s) with other portions of the vehicle other than the handlebar.

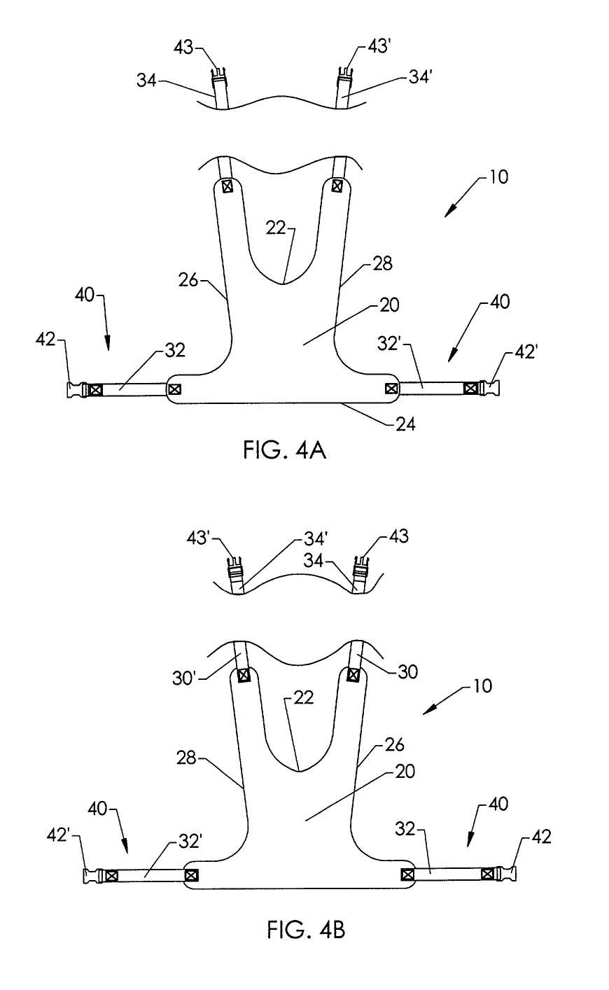

The embodiment shown in FIG. 1 shows extending from the back contacting portion a pair of straps 30, 30′ which constitute the handlebar attachment(s) 40. These two straps can be solid, or, as shown in the near strap 30, divided into two portions. For instance, the first portion 32 and the second portion 34 connected by a strap connector 42. Such a strap connector allows the present invention to be adjusted to fit an individual user's body shape and desires, for instance how far from the handlebars the user wishes to sit. Such a strap connector may actually fit upon the strap 30 in between the first portion 32 and the second portion 34 thereby allowing adjustment and lengthening and shortening of the strap 30, or may also comprise a releasable engageable fitting allowing the strap to be strapped and unstrapped together, as shown in the embodiment of FIGS. 4A-B.

Such as trap connector/adjuster could be located at any position along the strap and could be any possible means of connecting/adjusting, including, but not limited to: hook-and-loop (Velcro®), squeeze snaps, clips, ties, and buckles. The use of a strap connector is optional, in that the present invention could be manufactured and sold with non-adjustable straps, thereby removing any need for such a strap connector.

In another, less preferred embodiment, the user could sit on a surface such as the ground, with the user's feet or knees having the straps looped there around, thereby forming an impromptu back support for sitting on the ground or other surface.

In one example embodiment, the straps are made from twenty linear feet of one-inch to four-inch nylon web strapping material. Other strapping materials are also envisioned, as are other widths, etc. Examples of other materials includes, but is not limited to: flat strapping, cloth, wire, rope, bands, belts, strips, leashes, ties, restraints, plastic strapping, elastic strapping, etc. Such straps may additionally be padded.

Referring back to FIG. 1, the embodiment shown has contoured sides and a contoured top portion so that it more ideally comforts to the body shape of the user, for instance the user in FIG. 5. FIG. 5 shows an individual 8 using the present invention 10, the present invention cooperating with the handlebar 3 through straps connecting with the first handle 4 and the second handle 6. The user shown is sitting on a snowmobile 2.

Other embodiments show other shapes of the present invention, particularly the back contacting portion 20. However, any shape that is useful may be used, including the shapes shown as well as shapes not shown, for instance a square or rectangular back contacting portion would also be included within this description.

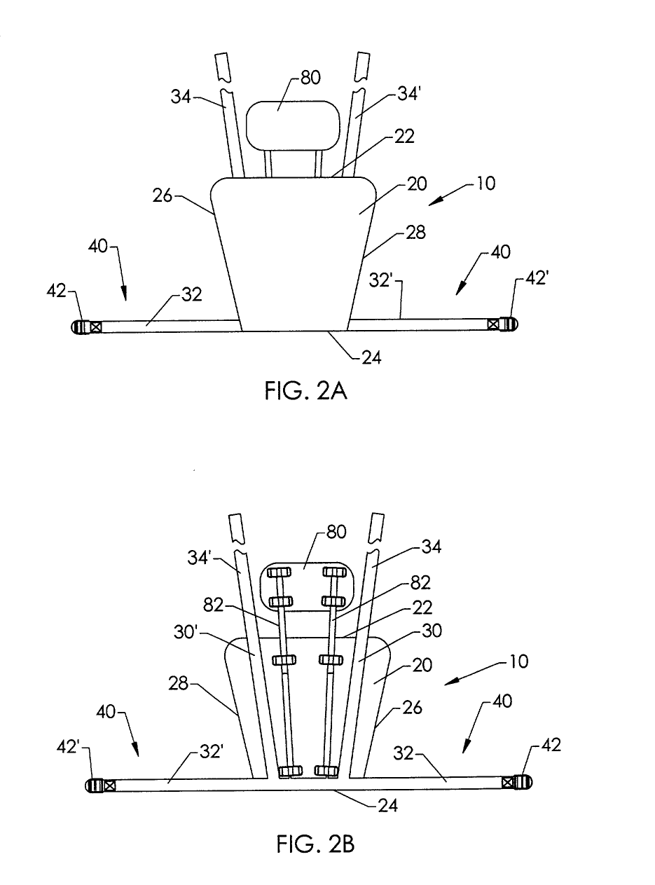

Referring now to FIGS. 2A and 2B, shown is a second embodiment of the present invention. This back rest 10 shows a back contacting portion 20 and a pair of handlebar attachments 40. In this embodiment, the back contacting portion 20 has a top 22, a bottom 24, a first side 26, and a second side 28. The straps 30, 30′ comprise of first portions 32, 32′ and second portions 34, 34′. In this embodiment, the far ends of the second portions 34, 34′ can be attached to the strap connectors 42, 42′.

Also shown in this embodiment is the utilization of a headrest 80. In this embodiment, the headrest is affixed on telescoping poles 82, which allow the headrest to be adjusted upwards or downwards as necessary for the user. This headrest is an optional feature, and may or may not be present in any individual embodiment. Utilization of such a headrest does not appreciable add to the size of the present invention in that when not in use, the back rest 10 can still be rolled up along the axis of the telescoping poles 82. Preferably, any embodiment of the present invention will be able to be “rolled-up” for storage purposes.

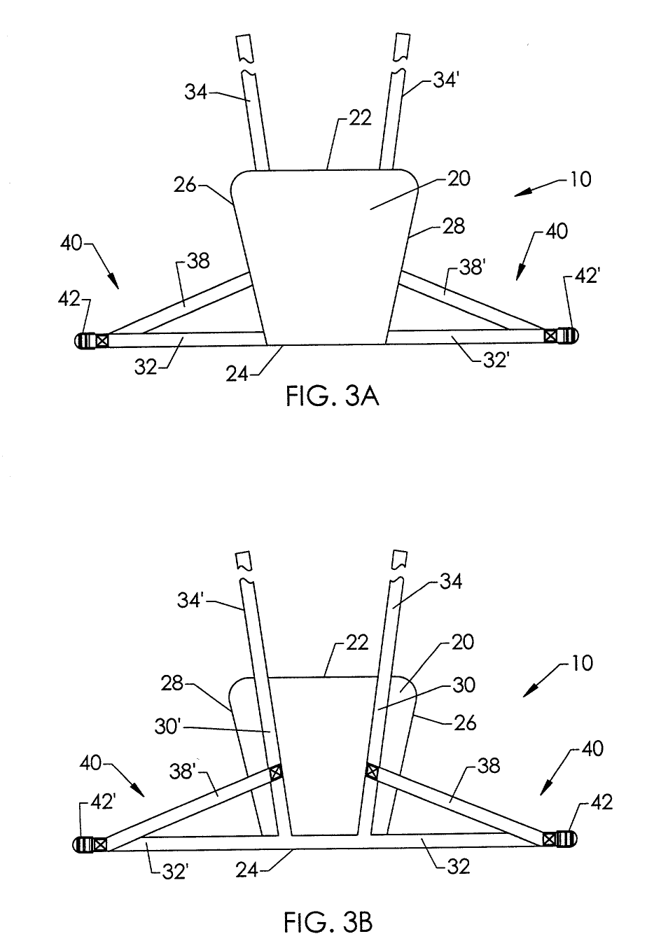

Referring now to FIGS. 3A and 3B, shown is a third embodiment of the present invention. This embodiment showing similar structures to the embodiment shown in FIG. 2A with the exception that the back contacting portion is differently shaped, as well as support straps 38, 38′ are added to add additional support to the present invention when in use, particularly adds lumbar support. The support straps stretching from the back contacting portion at an angle down to the strap connectors 42, 42′ adjacent to the first portions 32, 32′. Such support straps may be configured however suitable, being able to be attach however necessary to the back portion and other straps.

Referring now to FIGS. 4A and 4B, shown is a fourth embodiment of the present invention. This embodiment shows the utilization of quick release snap style connectors 42, 42′; 43, 43′ for creation of the loop forming the handlebar attachment 40. This embodiment also shows a more sculptured layout for the back contacting portion 20. With such layout, a pair of shoulder flanges and waist flanges are created for more comfortably fitting a user.

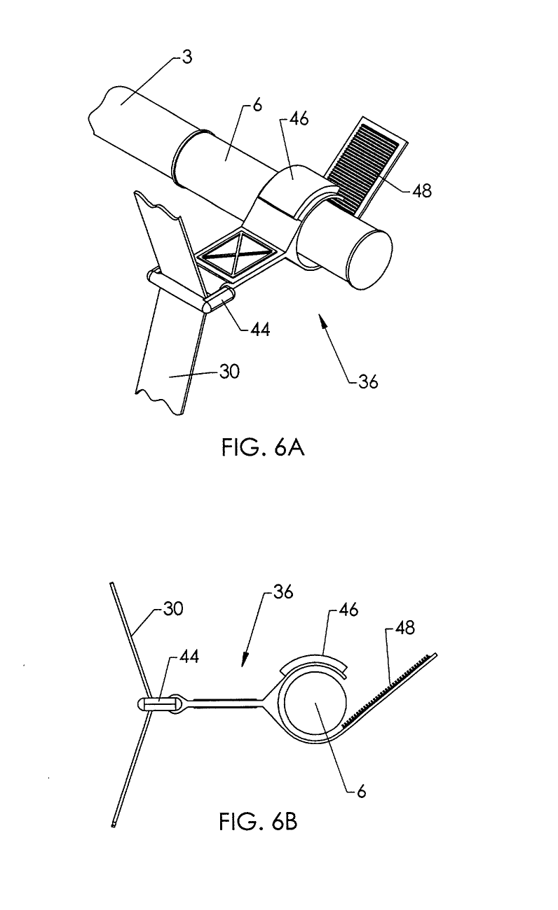

Referring now to FIG. 6A, shown is one embodiment of a manner of attaching the present invention to the handles of the vehicle in question. This embodiment shows attached to a strap 30 a slideable buckle 44 attaching to a hook and loop style fastener 36 having a hook end 46 and a loop end 48. Such an embodiment would be utilized on the second handle 6 of the handlebar 3, and preferable as well as one the first handle 4 (not shown). Through use of such a slideable buckle, the strap would be able to freely slide up and down through the buckle.

Referring now to FIG. 6B, a side view of FIG. 6A is shown, showing that the loop end 48 would merely need to stretched around the second handle 6 and attached through standard (Velcro®) hook and loop style attachment to the hook end 46. Other means of attaching the present invention to the handlebar are also envisioned aside from those shown in FIGS. 6A and 6B, as well as the simple looping around of the strap as shown in the other figures.

Additional possible features of the present invention include the addition of shoulder straps similar to backpack straps for added comfort, foldable neck rests, fold down (out of the inside bottom) seats for keeping a user's rear end clean and/or dry.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A back rest for a vehicle having a handlebar, said back rest comprising:
a back contacting portion for contacting a user's back; and
a handlebar attachment for connecting said back contacting portion to said handlebar.

2. The back rest of claim 1, wherein said handlebar attachment comprises at least one strap connected to said back contacting portion and for attachment to said handlebar.

3. The back rest of claim 2, wherein said handlebar attachment said back contacting portion to said handlebar further comprises a hook-and-loop style fastener attaching to said strap, said fastener able to be releasably attached to said handlebar by looping around said handlebar and attaching to itself.

4. The back rest of claim 2, wherein said strap is nylon.

5. The back rest of claim 2, wherein said strap is divided into two portions, each able to connect with one another through a connection means.

6. The back rest of claim 5, wherein said connection means is a hook-and-loop style fastener.

7. The back rest of claim 5, wherein said connection means is a releasable snap buckle.

8. The back rest of claim 1, wherein said handlebar comprises two handles, wherein said back contacting portion has a top opposite a bottom, wherein said handlebar attachment comprises a pair of strap loops each having a first end and a second end, wherein each of said first ends connect to said top, and wherein each of said second ends connect to said bottom.

9. The back rest of claim 8, wherein each of said strap loops loop around at least one of said handles.

10. The back rest of claim 1, wherein said handlebar has two handles, wherein said back contacting portion has a first side opposite a second side, wherein said handlebar attachment comprises a pair of strap loops each having a first end and a second end, wherein each of said first ends connect to said first side, and wherein each of said second ends connect to said second side, wherein each of said strap loops attach to at least one of said handles.

11. The back rest of claim 1, wherein said back contacting portion further comprises a headrest.

12. The back rest of claim 11, wherein said headrest is adjustable.

13. The back rest of claim 1, wherein said handlebar has two handles, wherein said back contacting portion has a top opposite a bottom, wherein said handlebar attachment comprises a pair of strap loops each having a first end and a second end, wherein each of said first ends connect to said top, and wherein each of said second ends connect to said bottom, wherein each of said strap loops loop around one of said handles.

14. The back rest of claim 1, wherein said back rest is configured for being rolled up and stored.

15. A back rest for a vehicle having a handlebar having a first end comprising a first handle and a second end comprising a second handle, said back rest comprising:
a back contacting portion for contacting a user's back; and
a handlebar attachment for attaching said back contacting portion to said handlebar,
said handlebar attachment comprising a first strap connecting with said back
contacting portion and connecting with said first handle, said handlebar
attachment further comprising a second strap connecting with said back
contacting portion and connecting with said second handle.

16. The back rest of claim 15, wherein said back contacting portion further comprises a headrest.

17. The back rest of claim 16, wherein said headrest is telescopically attached to said back contacting portion.

18. A back rest for a vehicle having a handlebar having a first end comprising a first handle and a second end comprising a second handle, said back rest comprising:
a back contacting portion for contacting a user's back, said back contacting portion having a top opposite a bottom; and
a handlebar attachment for connecting said back contacting portion to said handles, said handlebar attachment comprising a first strap loop having a first strap first end and a first strap second end, wherein said first strap first end connects to said top, and wherein said first strap second end connects to said bottom, said first strap loop able to connect with said first handle, said handlebar attachment further comprising a second strap loop having a second strap first end and a second strap second end, wherein said second strap first end connects to said top, and wherein said second strap second end connects to said bottom, said second strap loop able to connect with said second handle.

19. The back rest of claim 18, wherein said back contacting portion further comprises a headrest.

20. The back rest of claim 19, wherein said headrest is adjustable.
